(19) United States
(12) Patent Application Publication
(10) Pub. No.: US 2012/0133120 A1
(43) Pub. Date: May 31, 2012

(54) INDEXING TAB FOR STATIONERY

(75) Inventor: Chun-Ning TSENG, Rende Township (TW)

(73) Assignee: SMART FORTUNE INTERNATIONAL LIMITED, Taichung City (TW)

(21) Appl. No.: 12/955,089

(22) Filed: Nov. 29, 2010

(51) Int. Cl. B42F 21/00

(52) U.S. Cl. 283/36

(57) ABSTRACT

An indexing tab for stationery, of which the stationery is provided with an inserting portion for the indexing tab. The present invention is characterized in that the indexing tab has a snapping portion in a sheet pattern, which is inserted into the inserting portion of the stationery. A lateral flange is formed on one side of the snapping portion. A protruding portion is formed by the extension of the lateral flange of its snapping portion to define a first and a second end. The first end is linked to one side of the snapping portion. An identifier is linked to the second end of the protruding portion. The identifier can be protruded to provide visible classification and indexing effect, helping to improve the indexing function and convenience of the stationery.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an indexing tab, and more particularly to an innovative one which enables visible classification and indexing of the stationery.

2. Description of Related Art Including Information Disclosed Under 37 CFR 1.97 and 37 CFR 1.98

The common indexing tab for a binder is extensively used to improve the convenience in searching files due to its advantages including writing function and space saving.

This paper intends to explore the structural innovation of said indexing tab, which is generally designed into a long sheet to be inserted into an indexing tab inserting portion of the binder. Yet, the indexing effect of the indexing tab is insufficient if only letters are underlined for searching purposes, and the fast-growing customer demands cannot be met due to its simple appearance. Hence, there is still a room for improvement of the indexing tab.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

The “indexing tab” of the present invention is mainly characterized by that, the indexing tab includes a snapping portion, a protruding portion and an identifier, so the identifier could be protruded to provide visible classification and indexing effect, helping to improve the indexing function and convenience of the stationery.

The improvements brought about by this invention are as follow:

Based on the structural pattern wherein a prefolding line is set at the joint of the protruding portion and snapping portion, the protruding portion and identifier can be folded along the prefolding line correspondingly with the snapping portion. When the stationery is retracted, the indexing tab can be folded to prevent protrusion of the protruding portion and identifier, thus improving the applicability of the indexing tab.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the indexing tab of the present invention.

FIG. 2 is a first schematic example diagram of the indexing tab of the present invention.

FIG. 3 is a second schematic example diagram of the indexing tab of the present invention.

FIG. 4 is a third schematic example diagram of the indexing tab of the present invention.

FIG. 5 is a fourth schematic example diagram of the indexing tab of the present invention.

FIG. 6 is a fifth schematic example diagram of the indexing tab of the present invention.

FIG. 7 is a sixth schematic example diagram of the indexing tab of the present invention.

FIG. 8 is a schematic view of the present invention wherein the protruding portion and identifier are in a folding state.

### DETAILED DESCRIPTION OF THE INVENTION

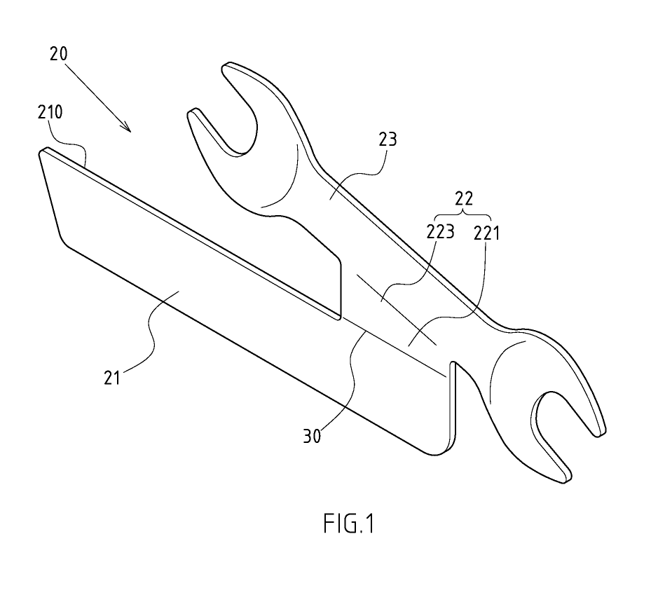

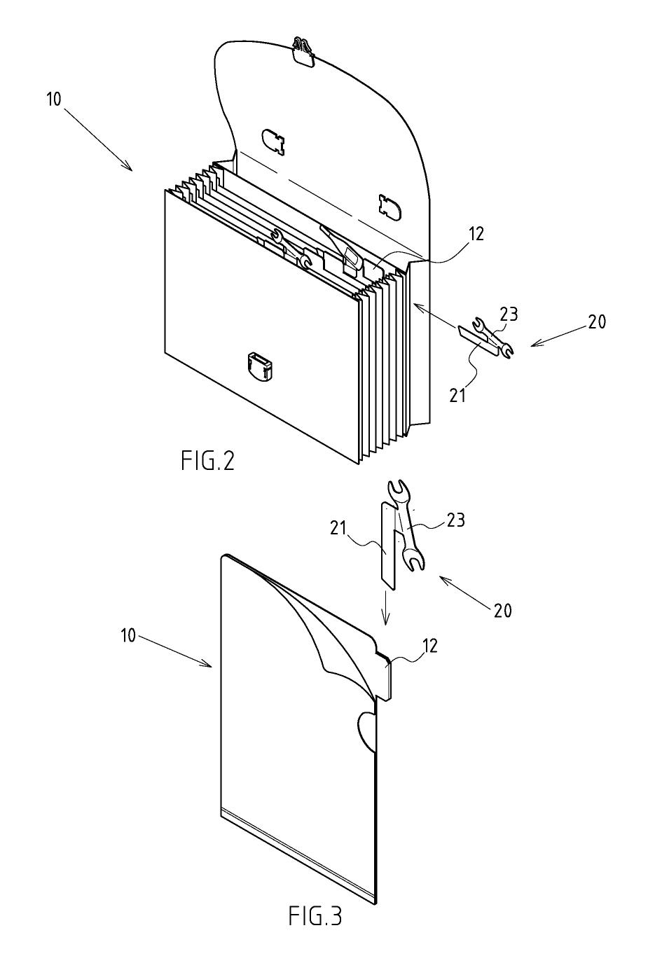

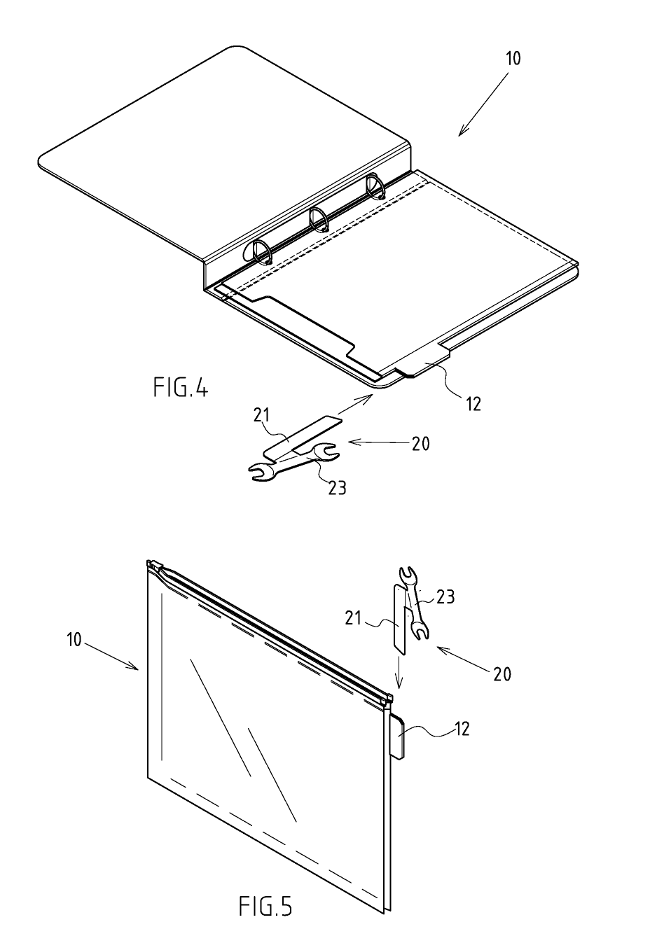

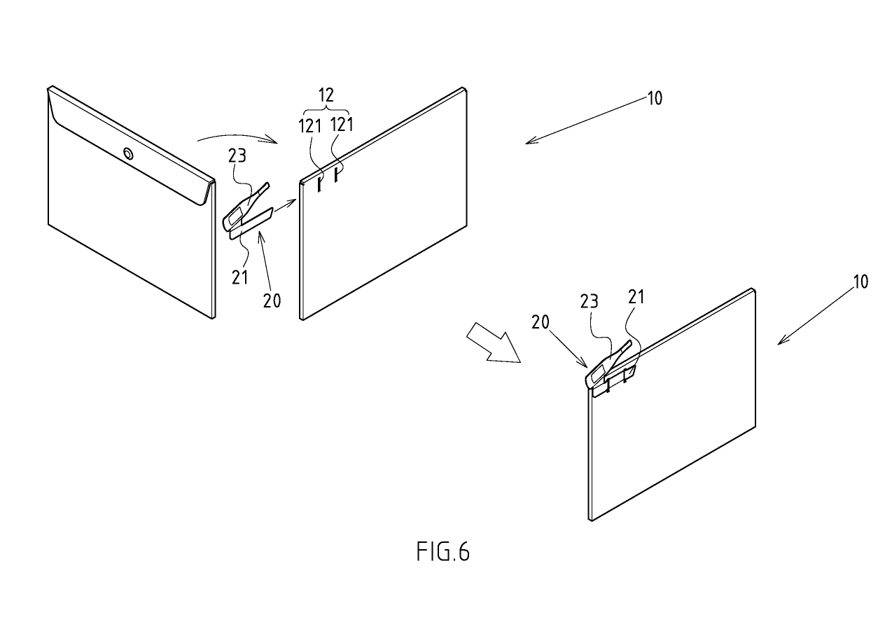

FIG. 1 depicts a preferred embodiment of an indexing tab of the present invention for stationery, which, however, is provided for only explanatory objective for patent claims. Said stationery 10 is provided with an inserting portion 12 for the indexing tab. There are a variety of stationeries 10, such as: expanding file, L-shaped binder, loose-leaf binder, zipped file folder, envelope file folder or tab divider(disclosed in FIGS. 2-7). The inserting portion 12 is available with different shapes in tune with the stationery 10, e.g.: the inserting portion 12 of expanding file is set at the top of the separator page (shown in FIG. 2); the inserting portion 12 of an L-shaped binder is set at either side (shown in FIG. 3); the inserting portion 12 of a loose-leaf binder is set on its periphery (shown in FIG. 4); the inserting portion 12 of a zipped file folder is also set on the periphery (shown in FIG. 5); the inserting portion 12 of an envelope file folder is set at the back and composed of two spaced slots 121 (shown in FIG. 6); the inserting portion 12 of the tab divider is set opposite to the binding side.

Of which the indexing tab 20 includes a snapping portion 21 in a sheet pattern, inserted into the inserting portion 10 of the stationery. A lateral flange 210 is formed on one side of the snapping portion 21.

A protruding portion 22 is formed by the extension of the lateral flange 210 of its snapping portion 21 to define a first end 221 and a second end 223. Of which the first end 221 is linked to one side of the snapping portion 21.

An identifier 23 is linked to the second end 223 of the protruding portion 22, enabling the indexing tab 20 to realize visible classification and indexing effects.

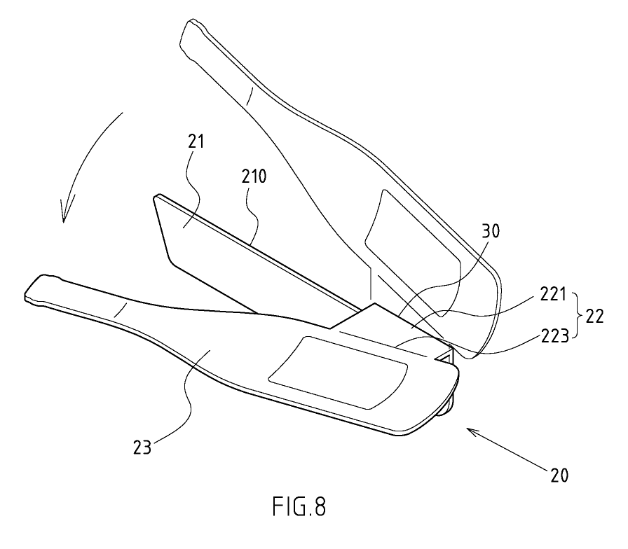

Of which, a prefolding line 30 is set at the joint of the protruding portion 22 and snapping portion 21, so that the protruding portion 22 and identifier 23 can be folded along the prefolding line 30 correspondingly with the snapping portion 21 (shown in FIG. 8). When the stationery 10 is retracted, the indexing tab 20 can be folded to prevent protrusion of the protruding portion 22 and identifier 23, thus improving the applicability of the indexing tab 20.

Of which, the indexing tab 20 with writing functions enables the users to mark the classified items or prompts for an improved indexing effect.

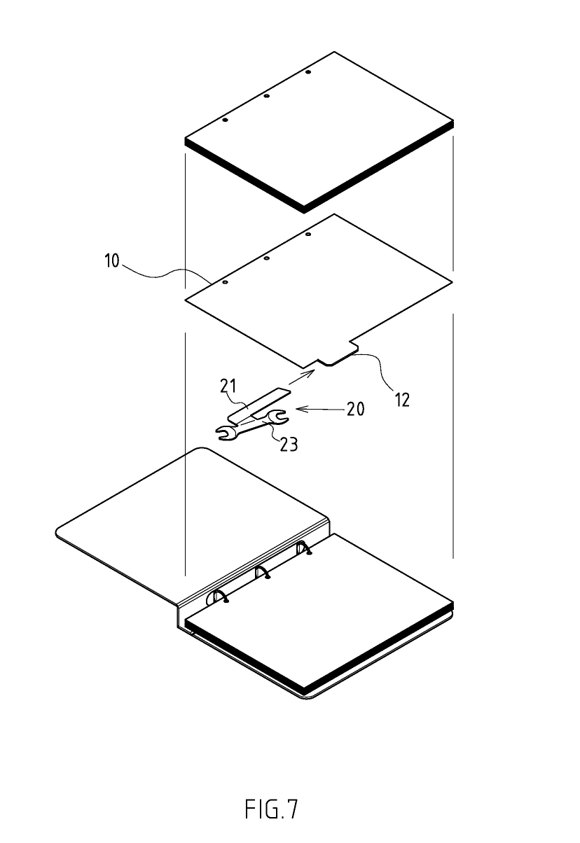

Based on above-specified structural configuration, the core of the indexing tab of the present invention lies in that, the indexing tab 20 has a snapping portion 21, a protruding portion 22 and identifier 23. As the snapping portion 21 is inserted into the inserting portion 12 of the stationery 10, the identifier 23 is located higher than the inserting portion 12, enabling visible classification and indexing of the stationery 10, and also alleviating the work burden with the vivid appearance of the identifier 23. The identifier 23 can be configured into any shape, as shown in FIGS. 1, 7, wherein the identifier 23 is configured separately into the shape of spanner and bottle, so a novel indexing tab 20 is created to meet diversified user demands with improved indexing functions.

1. An indexing tab for stationery, of which said stationery is provided with an inserting portion for the indexing tab, the indexing tab comprising:
a snapping portion in a sheet pattern, inserted into the inserting portion of the stationery, a lateral flange being formed on one side of the snapping portion;
a protruding portion formed by the extension of the lateral flange of its snapping portion to define a first and a second end, the first end is linked to one side of the snapping portion; and
an identifier linked to the second end of the protruding portion.

2. The structure defined in claim 1, wherein a prefolding line is set at the joint of the protruding portion and snapping portion, so that the protruding portion and identifier can be folded along the prefolding line correspondingly with the snapping portion.

3. The structure defined in claim 1, wherein the indexing tab is available with writing functions.

4. The structure defined in claim 1, wherein said stationery is configured into either of the following patterns: expanding file, L-shaped binder, loose-leaf binder, zipped file folder, envelope file folder or tab divider.
